(19) United States
(12) Patent Application Publication
(10) Pub. No.: US 2007/0245587 A1
(43) Pub. Date: Oct. 25, 2007

(54) Drying and/or Cooling Conveyor

(76) Inventor: Matthew Cottam, Lancashire (GB)

Correspondence Address: EGBERT LAW OFFICES, 412 MAIN STREET, 7TH FLOOR, HOUSTON, TX, 77002, US

(21) Appl. No.: 11/569,936

(22) PCT Filed: Jun. 15, 2005
(86) PCT No.: PCT/GB05/02358

§ 371 Date: Dec. 1, 2006

(30) Foreign Application Priority Data
Jun. 28, 2004 (GB) 0414381.4

(51) Int. Cl. F26B 15/18

(52) U.S. Cl. 34/66

(57) ABSTRACT

A drying and/or cooling conveyor includes a chamber within which is located at least one conveyor belt for the transportation of articles to be cooled and/or dried through the chamber. An air conditioning device is provided that includes ductwork for supplying air to and removing air from the chamber. This ductwork forms a framework to which the conveyor belt is mounted. An independent support for the conveyor belt is not required, which significantly simplifies the structure of the conveyor as a whole. Preferably, the ductwork is also used to support a housing defining the chamber via feet that project through the base of the housing to support the housing off the floor. The ductwork is therefore used to support substantially the whole structure of the conveyor.

The present invention relates to a drying and/or cooling conveyor (hereinafter and in the claims referred to as a ‘drying/cooling conveyor’) which has been designed in particular but not exclusively for use with heat-sensitive products such as are produced in the food industry.

Drying/cooling conveyors are used in production plants to dry and/or cool articles as they pass between stages of a production process. For example, in the food industry it is convenient to cool and to dry food articles which emerge from an oven as they are transported to the next stage within the plant. This stage may be simply a packaging stage or may comprise other production stages such as enrobing, decorating or the like.

Conventionally a drying/cooling conveyor comprises a chamber through which the articles to be dried are transported on a conveyor belt. Conditioned air is blown into the chamber to cool and/or dry the articles on the belt. However, such conveyors have several disadvantages. In particular, they can be difficult to clean as the conveyor is enclosed within ductwork used to supply and remove the air to and from the chamber. Conventional drying/cooling conveyors also tend to blow conditioned air past the articles passing through the conveyor but then allow the spent air to find its own way out of the chamber or to an intake of the air conditioning system.

It is an object of the present invention to overcome or substantially mitigate the aforesaid disadvantages.

According to the present invention there is provided a drying/cooling conveyor comprising a chamber within which is located at least one conveyor belt for the transportation of articles to be cooled and/or dried through the chamber; and air conditioning means comprising ductwork for supplying air to and removing air from the chamber, the ductwork forming a framework to which the conveyor belt is mounted.

The advantage of using the air conditioning ductwork to mount and support the conveyor belt is that an independent support means is not required, which significantly simplifies the structure of the conveyor as a whole.

Preferably, the ductwork is also used to support a housing defining the chamber.

Preferably also, the ductwork is connected to feet that project through the base of the housing to support the housing off the floor.

It will be appreciated, therefore, that the ductwork is used to support substantially the whole structure of the conveyor.

Preferably also, the ductwork comprises a plurality of risers between which horizontal tubes are connected.

Preferably also, the horizontal tubes are releasably connected to the risers so that they can be removed individually for cleaning or replacement.

Preferably also, the conveyor belt or belts have an open structure permitting air to flow therethrough.

Preferably also, the conveyor belt travels around the horizontal tubes, which are provided with apertures through which air can be blown.

Preferably also, the apertures in the tubes comprise slots in order that a curtain of air can be blown upwardly through the conveyor belt past any article located thereon.

Preferably also, the horizontal tubes provided with the apertures can be rotated to vary the direction of the air being blown therethrough.

Preferably also, a plurality of separate conveyor belts is arranged with the belts vertically one above the other in tiers.

Preferably also, each tier is staggered with respect to its neighbouring tier or tiers so that articles traveling along an upper tier can be transferred to a lower tier by falling off an end of an upper tier onto an underlying end of a lower tier.

Preferably also, the direction of travel of the conveyor belt or belts in each tier is opposite to that of the conveyor belt or belts in its neighbouring tier or tiers.

Preferably also, the conveyor comprises at least three tiers.

Preferably also, each tier comprises a single conveyor belt.

Preferably also, the speed of travel of the belt in each tier can be adjusted to be different from that of its neighbouring tier or tiers. Advantageously, the speed of travel of the conveyor belts successively increases from tier to tier in a vertically downwards direction. In this way, articles passing through the conveyor can be bunched up more closely as they cool for more efficient processing at the next stage of a production process. Alternatively, however, it will be appreciated that by successively decreasing the speed of travel the articles being cooled can be more widely spaced if this is desired.

Preferably also, a crumb collection sheet is located in a lower part of the chamber beneath all of the conveyor belts.

Preferably also, the housing comprises a roof which has an arched interior surface. The advantage of this is that any condensation which forms on the interior surface of the roof runs off the sides rather then dripping into the chamber and potentially damaging articles passing through the conveyor.

Preferably also, the air conditioning means comprises at least one air cooling means through which air is drawn from the chamber prior to be blown under pressure into the ductwork.

Preferably also, the air conditioning means comprises an extraction duct which is located in the roof of the chamber and which feeds air extracted from the chamber to a desiccant dehumidifier.

Preferably also, the dehumidifier is located externally of the chamber.

Preferable also, the dehumidifier feeds dried air back into the chamber is proximity to an inlet to the air cooling means.

The air conditioning arrangement is arranged so that conditioned air which has been cooled and dried appropriately for the articles passing through the conveyor is led through circular path which passes upwardly through the conveyor. If the articles are primarily to be cooled then, given that warm air rises, the flow of air upwardly through the conveyor, past the articles to be cooled for extraction from the roof of the chamber follows the natural direction of the convention current within the chamber. Similarly, if the articles are to be dried then, for any given temperature, moist air tends to rise above dry air so that the upward flow of air through the chamber follows the natural direction of the convention current. Hence, in both cases the air flow reinforces the natural state and makes the cooling and/or drying of the articles within the conveyor more efficient.

An example of the present invention will now be described by way of example with reference to the accompanying drawings in which:

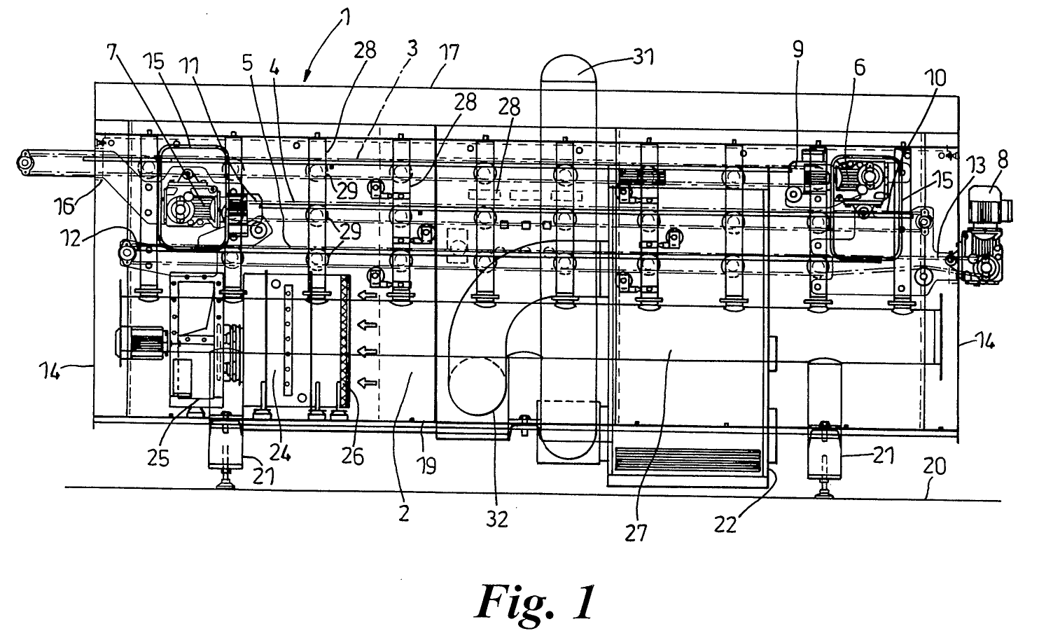

FIG. 1 is a side view of the interior of a drying/cooling conveyor in accordance with the present invention; and

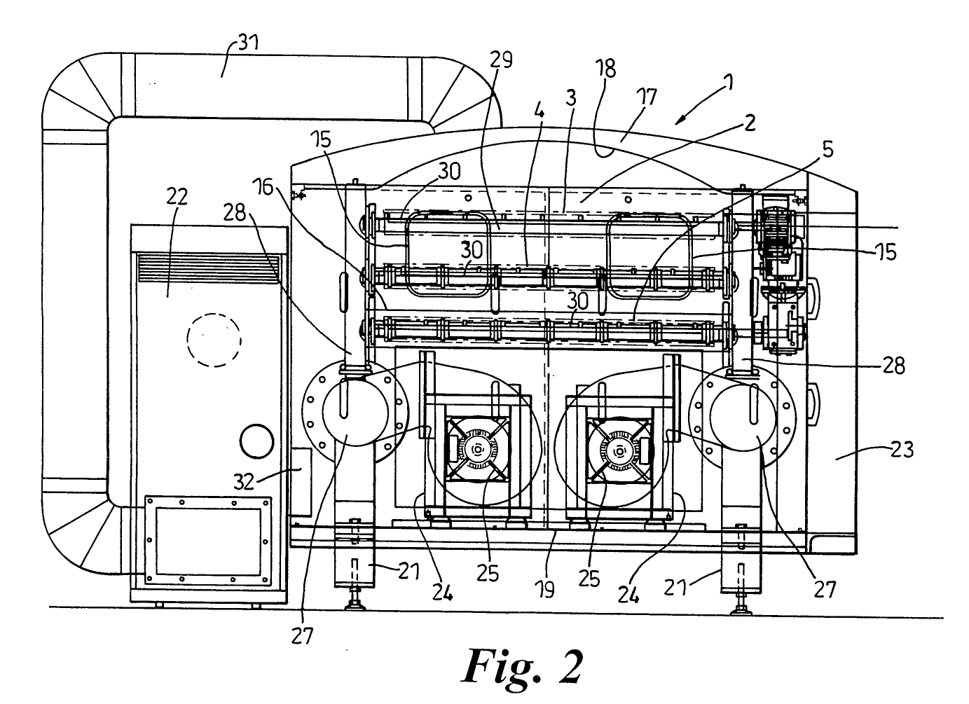

FIG. 2 is an end view of the interior of the conveyor shown in FIG. 1 in the direction of the arrow II.

The drying/cooling conveyor shown in the drawings comprises a housing 1 defining a chamber 2 in which three conveyor belts 3, 4, 5 respectively are located. An air conditioning means, as is described in detail below, is provided to provide a supply of conditioned air that is blown through the conveyor belts 3, 4, 5 to cool and/or dry articles traveling along them through the conveyor, as required. Each of the belts 3, 4, 5 therefore comprises an open, porous structure to permit the passage of air therethrough. Such belts can comprise any suitable conventional belt made of mesh, open slats, wire or the like.

The belts 3, 4, 5 are arranged vertically one above the other in three tiers and driven by associated motors and gearing 6, 7, 8 respectively. Each tier comprises a single conveyor belt and is staggered with respect to its neighbouring tier or tiers so that articles traveling along the conveyor belt 3 comprising the uppermost tier are transferred to the middle conveyor belt 4 by falling off an end 9 of the belt 3 onto an underlying end 10 of the belt 4. Similarly, articles fall off the opposite end 11 of the belt 4 onto an underlying end 12 of the belt 5 before exiting from the conveyor from the other end 13 of the belt 5. It will be appreciated that the direction of travel of each of the conveyor belts 3, 4, 5 is opposite to that of its neighbouring belt or belts. In this way articles enter the conveyor at one end thereof on the uppermost belt 3, travel along the belts 3, 4 and 5 before exiting from the conveyor at its opposite end on the lowermost belt 5. More or fewer belts could be provided, as desired, in any given embodiment to reduce the floor area taken up by the conveyor but three tiers provides a balance between appropriate dwell time within the conveyor and the floor area taken up by the conveyor for most applications.

The housing 1 is provided with pairs of doors 14 at its ends and viewing windows 15 both through the doors 14 and along its sides. Slots 16 are provided in the doors 14 through which the entry end exiting ends of the conveyor belts 3 and 5 project. A roof 17 of the housing is provided with an arched interior surface 18 in order to prevent condensation from collecting and dripping into the chamber 2. At the bottom of the housing 1, is a base 19 the interior surface of which comprises a smooth sheet, preferably of stainless steel. Crumbs and other debris which fall from articles traveling along the belts 3, 4, 5 is intended to fall through the open structure of the belts 3, 4, 5 and collect on the interior surface of the base 19, which has therefore been designed to be easily cleaned on a regular basis. The housing 1 is supported above floor level 20 by height-adjustable feet 21 which project through the base 19. As described below, these feet 21 are connected to but sealed from the ductwork for an air conditioning means for the conveyor.

Part of the air conditioning means comprises a desiccant dehumidifier 22. In the present embodiment, the dehumidifier 22 is free-standing and located at one side of the housing 1. In other embodiments, however, the dehumidifier 22 could be located within the housing 1, preferably close to the roof 17, On the opposite side of the housing 1 from the dehumidifier 22 is a control panel 23 for controlling the air conditioning means and the operation and speed of the conveyor belts 3, 4, 5.

Within the housing 1, the ductwork for the air conditioning means is used to form a framework to which the conveyor belts 3, 4 5, are mounted. These air conditioning means and its associated ductwork will now be described.

Within the chamber 2, the air conditioning means comprises a pair of air cooling coils 24 which are mounted on the base 19 at one end of the conveyor. Air is drawn into the coils 24 by motor driven fans 25 via filters 26 from the interior of the chamber 2. From the coils 24 the cooled air is blown under pressure into two horizontal pipes 27 that run along the sides of the housing 1 and for the full length of the conveyor. The height-adjustable feet 21 for the housing 1 are connected to the pipes 27. In addition, spaced at regular intervals along the length of each of the pipes 27 is a series of risers 28 such that pairs of risers 28 are arranged opposite one another along the length of the conveyor. Between each of the pairs of risers 28 are connected three, vertically spaced, horizontal tubes 29. The conveyor belts 3, 4, 5 travel around the horizontal tubes 29 at each vertical level respectively. The belts 3, 4, 5 are therefore mounted on and supported by the risers 28 and tubes 29.

The horizontal tubes 29 are each provided with apertures 30 through which the air exits from the ductwork. The apertures 30 preferably comprise elongate slots in order that curtains of air can be blown upwardly and evenly through the conveyor belts 3, 4, 5 across their full width past articles located thereon. As an alternative to the apertures 30, appropriately shaped nozzles could be provided. In order that the direction of the curtain of air can be varied, the horizontal tubes 29 can be rotated relative to the risers 28.

Mounted in an upper part of the chamber 2, preferably through the roof 17, is an air extraction hood (not shown) connected to an extraction duct 31 that feeds air from the chamber 2 to the desiccant dehumidifier 22, which includes a fan (not shown) to suck the air from the chamber 2. The dehumidifier 22 is used to dry the air from the chamber 2, when required, and then feeds the dried air back into the chamber 2 via an inlet duct 32 that enters the base of the chamber 2 in close proximity to the filter 26 covering the inlet to the cooling coils 24.

If the dehumidifier 22 is used, the temperature of the air being fed back into the chamber 2 can be relatively high, hence the need for the cooling coils even if cooling is not a requirement of the conveyor as this air may be too hot for some articles, for example food articles covered in or containing chocolate.

As described above, the flow or air through the conveyor follows the natural convection currents regardless of whether the conveyor is use either for drying articles or for cooling articles. It will be appreciated that the dehumidifier 22 and the cooling coils 24 are controlled to condition the air to the temperature and humidity requirements for the particular articles being dried and/or cooled in the conveyor.

In use, the aforementioned air conditioning requirements are set up and articles to be dried and/or cooled are fed into the conveyor via the projecting end of the conveyor belt 3. The articles then proceed through the conveyor, falling from belt 3 onto belt 4 and finally onto belt 5 before exiting via the end 13 that projects from the opposite end of the conveyor. During their passage along the conveyor belts 3, 4, 5, curtains of appropriately conditioned air are blown upwardly over them via the apertures 30 in the horizontal tubes 29. These curtains of air are made as even as possible over the width of the conveyor belts 3, 4, 5 to ensure that articles located along the edges of the belts are treated the same as those located centrally.

The speed of operation of the conveyor belts 3, 4, 5 can be used to determine the dwell time of articles within the conveyor, as appropriate. In addition as indicated above, the individual speed of each belt can be set to bunch or to separate the articles as they fall from each tier of the conveyor to the next. However, with an article that comprises a continuous rope or strap, then the conveyor belts 3, 4, 5 must all travel at the same speed. It will also be appreciated that the width, length, depth and spacing of the conveyor belts 3, 4, 5 can be adapted to suit the articles to be dried and/or cooled. For example, with a continuous rope or strap, the belts 3, 4, 5 do not need to be widely spaced vertically but the depth of each individual conveyor belt 3, 4, 5 would typically made higher than would otherwise be the case to prevent breakage of the rope or strap as it travels around the curved end of each belt down to a lower tier.

It will thus be appreciated that the drying/cooling conveyor of the invention overcomes the aforementioned problems of conventional conveyors in that it is easily cleaned. In particular, all of the internal ductwork of the air conditioning system will be typically made of stainless steel and interconnected using conventional dairy standard connections. This means that individual pieces of ductwork can be readily removed for cleaning or replacement. As this ductwork supports the whole structure of the conveyor, no further supporting framework is required. Also, as the conveyor provides ductwork for the remove of the spent conditioned air from the chamber it can utilize an air flow pattern that is much more efficient than conventional conveyors.

In addition to the foregoing, in embodiments of the conveyor such as that described above the use of a three-tier conveyor belt arrangement ensures factory floor-space can also be utilized effectively.

1. A drying/cooling conveyor comprising.
a chamber having at least one conveyor belt for the transportation of articles to be cooled and/or dried through said chamber, said at least one conveyor belt being located within said chamber; and
air conditioning means comprising ductwork supplying air to and removing air from said chamber, said ductwork forming a framework, said conveyor belt being mounted to said framework.

2. A conveyor as claimed in claim 1, wherein said chamber is defined by a housing, said ductwork supporting said housing.

3. A conveyor as claimed in claim 2, wherein said housing having a base with feet projecting therefrom, said ductwork being connected to said feet and supporting said housing.

4. A conveyor as claimed in claim 1, wherein said at least one conveyor belt has an open structure permitting air to flow therethrough.

5. A conveyor as claimed in claim 1, wherein said ductwork comprises a plurality of risers and horizontal tubes connected between the risers.

6. A conveyor as claimed in claim 5, wherein said horizontal tubes are releasably connected to the risers, each horizontal tube being able to be removed individually.

7. A conveyor as claimed in claim 5, wherein the conveyor belt travels around the horizontal tubes, said horizontal tubes being provided with apertures through which air can be blown.

8. A conveyor as claimed in claim 7, wherein said apertures in the tubes comprise slots, said conveyor belt having a curtain of air blown upwardly therethrough past articles located thereon.

9. A conveyor as claimed in claim 7, wherein the horizontal tubes are rotated to vary direction of air being blown therethrough.

10. A conveyor as claimed in claim 1, wherein said at least one conveyor belt is comprised of a plurality of separate conveyor belts arranged with the belts vertically one above another in tiers.

11. A conveyor as claimed in claim 10, wherein each tier is staggered with respect to a neighboring tier, said articles traveling along an upper tier being transferred to a lower tier by falling off an end of the upper tier onto an underlying end of a lower tier.

12. A conveyor as claimed in claim 10, wherein said plurality of separate conveyor belts have a direction of travel in each tier opposite to a direction of the conveyor belt in a neighboring tier.

13. A conveyor as claimed in claim 10, wherein said plurality of separate belts is comprised of at least three tiers.

14. A conveyor as claimed in claim 10, wherein each tier comprises a single conveyor belt.

15. A conveyor as claimed in 10, wherein each belt has a speed of travel in each tier adjusted to be different from a speed of a belt in in a neighboring tier.

16. A conveyor as claimed in claim 15, wherein said speed of travel of the conveyor belts either successively increases or successively decreases from tier to tier in a vertically downwards direction.

17. A conveyor as claimed in claim 1, further comprising:
a crumb collection sheet located in a lower part of said chamber beneath said at least one conveyor belt.

18. A conveyor as claimed in claim 1, wherein said housing comprises a roof having an arched interior surface.

19. A conveyor as claimed in claim 1, wherein said air conditioning means comprises at least one air cooling means through which air is drawn from said chamber prior to be blown under pressure into said ductwork.

20. A conveyor as claimed in claim 1, wherein said air conditioning means comprises an extraction duct connected to an upper part of said chamber and feeding air extracted from said chamber to a desiccant dehumidifier.

21. A conveyor as claimed in claim 20, wherein said dehumidifier is located externally of said chamber.

22. A conveyor as claimed in claim 18, wherein said air conditioning means comprises an extraction duct connected to an upper part of said chamber and feeding air extracted from said chamber to a desiccant dehumidifier, and wherein said dehumidifier feeds dried air back into the chamber in proximity to an inlet of said air cooling means.
